(19) United States
(12) Patent Application Publication
(10) Pub. No.: US 2012/0187749 A1
(43) Pub. Date: Jul. 26, 2012

(54) Generating axle

(76) Inventor: Thomas Grady, Mclean, VA (US)

(21) Appl. No.: 12/925,016

(22) Filed: Aug. 23, 2011

Related U.S. Application Data
(60) Provisional application No. 61/278,844, filed on Oct. 14, 2009.

(51) Int. Cl. B60L 11/00; B60B 35/12

(52) U.S. Cl. 301/124.1

(57) ABSTRACT

Generators are not new. They have been around for a long time. We find them in windmills, in hydroelectric dams, and in many other applications where kinetic energy, in these cases in the form of wind and falling water, is harnessed and turned into electricity. I propose to harness the kinetic energy of an automobile (and other devices) by turning the axles into generators. I propose to do this by wrapping the axles in wire and either magnetizing the axle tube or lining it with magnets on two sides. Then, when the axle spins, the wire will turn in a magnetic field, thereby creating electricity which can be routed directly to the battery to prolong its charge.

### CROSS REFERENCE TO RELATED APPLICATIONS

I do not claim the benefit of one or more prior filed co-pending non-provisional applications.

### BACKGROUND

The spinning motion of a car's axle is, in my opinion, wasted kinetic energy. Therefore, I have come up with an invention that harnesses this energy. I have decided to call my invention the “Generating Axle”. As I said above, I feel that the motion of a spinning car axle is wasted kinetic energy, and the Generating Axle will harness that energy and convert it to electricity, thereby increasing range on electric cars or fuel efficiency on gasoline powered cars, as the electricity can be used to power accessories, and the gas engine will no longer be required to drive a generator or alternator.

### A BRIEF SUMMARY OF THE INVENTION

On an electric car, the generating axles will act as four generators which will constantly recharge the battery, thereby increasing range. I propose to create the largest armature possible on each of the four half shafts which exist on current automobiles. One of the nice things about this invention is that current automobiles will need very little modification to install this device. Currently, half shafts (axles) are housed in tubes to protect them from weather and road debris. I propose fixing magnets on the part of the tube adjacent to where the armature will be located. I propose doing this on all four half shafts creating, in effect, four generators which will harness the motion of turning wheels and convert it to electricity. I would recommend making the armature take up as much of the axle as possible. The idea for this can be viewed pictorially in FIG. 1, the top view of this device. Creating the armatures: There are a couple of ways to do this. One way would be simply to wind copper around the axle and create a “bubble” in the axle tube where this wire is located to give it room to spin. The other way, and to me the preferable way, is to grind a channel in each axle, and wind the wire in there, thereby making the armature portion of the axle the same diameter as the rest of the axle. Whichever way is decided to be best, there would be magnets fixed in the axle tube (or the tube itself could be magnetized) at the exact spot of the wire wrapping, so that when the axle turns, the wire will turn inside the magnetic field, thereby creating electricity. This can be viewed pictorially in FIG. 2, the cutaway view of this device.

### BRIEF DESCRIPTION OF THE SEVERAL VIEWS OF THE DRAWING

FIG. 1 gives you a view of the front end of an automobile as seen from the top. The armatures, which are the axles wrapped in wire, are inside of an axle tube anyway to keep the axles from road debris and water. I propose putting magnets in the tubes or magnetize the tubes themselves.

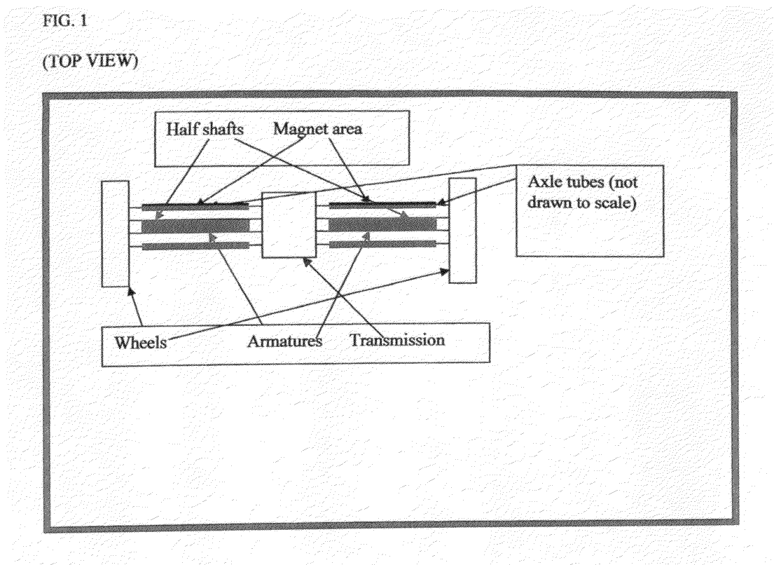

FIG. 2 gives a cutaway drawing of the axle as if we were looking at it from the outside end, where the wheel is. You can see from the drawing that the axle is wrapped in wire and is inside the tube, which for the purposes of this drawing is labeled “Magnetized axle tube.”

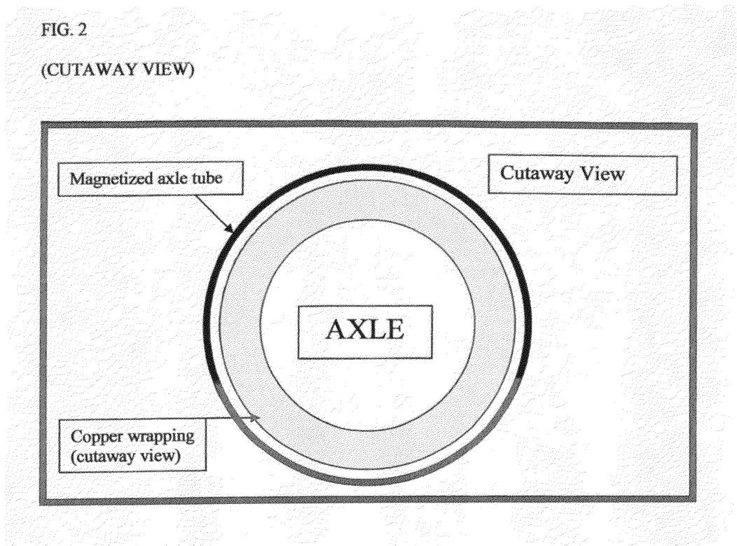

### A DETAILED DESCRIPTION OF THE INVENTION

The Generating Axle is an invention which will use the kinetic energy of an automobile in new ways by harnessing the car's movement and turning that power into electricity. This is done by basically turning the axles into generators. This will be done by one of a few ways. Either the axle will be wrapped in wire to create the armature, or a channel will be dug in the axle for most of its length in which the wire will be wrapped. Either way, the axle tubes will then either be lined on two sides with magnets or magnetized themselves. What this will do is generate electricity as the axle turns, thereby utilizing the car's kinetic energy to produce power.

The Generating Axle will turn at a speed based on the wheel diameter and the vehicle speed. For instance, if a vehicle has a wheel diameter of 15″, then it has a circumference of: 22/7=x/15. Therefore, x=15×22/7, or approximately 47.14 inches. A mile is 5280 feet, or 12×5280 inches, or 63360 inches. This means a fifteen inch wheel will revolve approximately 1344 times in one mile. Therefore, the axle will turn the same number of times, meaning that, at 60 mph, the generating axle will turn at 1344 rpm. Remember, also, that since vehicles utilize half shafts, there will be four generators turning simultaneously. At 30 mph, it will turn at 672 rpm.

Please note that, with this device, the smaller the wheel, the more generating power. This will become even more important as vehicle sizes shrink to meet CAFÉ standards, and as electric cars start to enter the fleet en masse, as they are generally smaller. For instance, using the same calculations for above, a 12 inch wheel will turn the generating axle at 1680 rpm at 60 mph.

1. I claim that turning the axle of a vehicle into a generator to harness the vehicle's kinetic energy is a new approach and therefore must be protected under this patent.)

2. I claim the protection under #1 whether the axle in question is on an automobile, a truck, a bike, or any other device which utilizes an axle.
